(19) United States
(12) Patent Application Publication
(10) Pub. No.: US 2006/0037221 A1
(43) Pub. Date: Feb. 23, 2006

(54) Business card assembly and method of distributing

(76) Inventor: Daniel M. Reynolds, Tempe, AZ (US)

Correspondence Address: Daniel M. REYNOLDS, Unit 51, 122 South Hardy Drive, Tempe, AZ, 85281, US

(21) Appl. No.: 10/924,323

(22) Filed: Aug. 23, 2004

(51) Int. Cl. G09F 7/00

(52) U.S. Cl. 40/124.04

(57) ABSTRACT

A business card assembly and a method of distributing the business card assembly are described. The business card assembly comprises a frame, and a plurality of business cards containing business information coupled to the frame and configured to be removed from the frame. Furthermore, the business card assembly includes an assembly coupling feature coupled to the frame and configured to attach the business card assembly to a fixture on a residential, commercial, or industrial facility. Additionally, the method for disseminating the business information includes door-to-door distribution of the business card assembly.

### BACKGROUND OF THE INVENTION

1. Field of the Invention

The present invention relates to a business card assembly and a method of distributing and, more particularly, a business card assembly comprising a frame and a plurality of business cards coupled thereto and a method of distributing the business card assembly.

2. Description of Related Art

In an effort to disseminate business information and proliferate business opportunities, a sheet of business cards can be prepared, whereby one or more business cards of interest to the consumer can be separated from the sheet. However, the inventor has observed that such sheets of business information lack adequate methods of distribution.

### SUMMARY OF THE INVENTION

One aspect of the invention is to reduce or eliminate any or all of the above-described problems.

Another object of the invention is to provide a business card assembly comprising a plurality of business cards.

Another object of the invention is to provide a method of distributing a business card assembly.

According to another aspect, a method of distributing a business card assembly is described comprising: preparing a business card assembly comprising a frame, a plurality of business cards coupled to the frame and configured to be removed from the frame, and an assembly coupling feature coupled to the frame; and distributing the business card assembly door-to-door to one or more of a residential, commercial, or industrial facility using the assembly coupling feature to couple the business card assembly to a fixture on the one or more of the residential, commercial, or industrial facility.

According to yet another aspect, a business card assembly is described comprising: a frame; a plurality of business cards coupled to the frame and configured to be removed from the frame; and an assembly coupling feature coupled to the frame and configured to couple the business card assembly to a fixture on one or more of a residential, commercial, or industrial facility.

### BRIEF DESCRIPTION OF THE DRAWINGS

In the accompanying drawings:

FIG. 1 depicts a business card assembly according to an embodiment of the invention;

FIG. 2 depicts a business card assembly according to another embodiment of the invention;

FIG. 3 depicts a business card assembly according to another embodiment of the invention; and

FIG. 4 illustrates a method of distributing a business card assembly according to another embodiment of the invention.

### DETAILED DESCRIPTION OF EXEMPLARY EMBODIMENTS

In the following description, to facilitate a thorough understanding of the invention and for purposes of explanation and not limitation, specific details are set forth, such as a particular configuration of the business card assembly and various descriptions of the distribution of the business card assembly. However, it should be understood that the invention may be practiced with other embodiments that depart from these specific details.

Nonetheless, it should be appreciated that, contained within the description are features which, notwithstanding the inventive nature of the general concepts being explained, are also of an inventive nature.

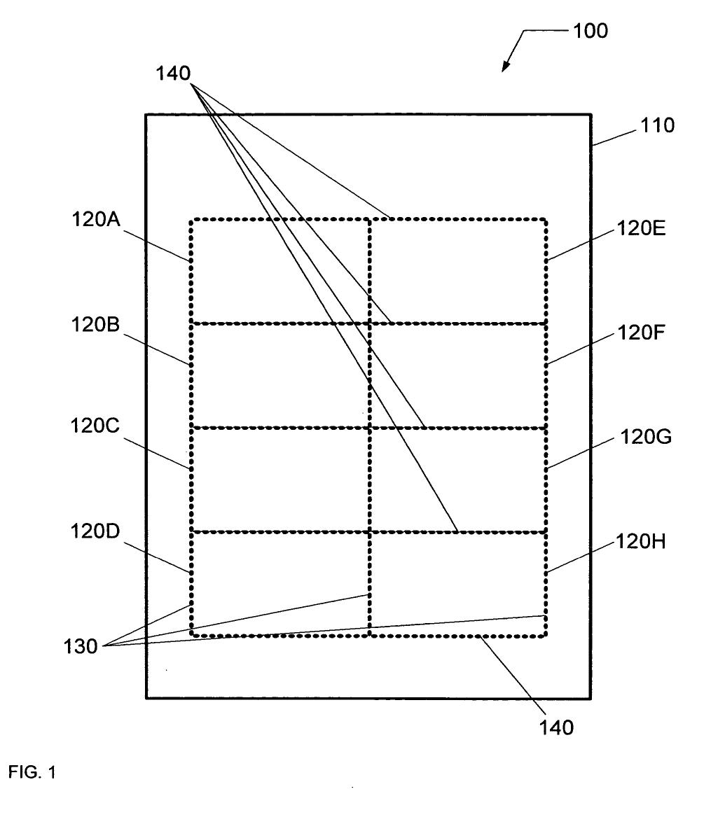

Referring now to the drawings, wherein like reference numerals designate identical or corresponding parts throughout the several views, FIG. 1 depicts a business card assembly 100 comprising a frame 110 and a plurality of business cards 120A, 120B, 120C, 120D, 120E, 120F, 120G, and 120H according to one embodiment. Each business card can include business information, such as, but not limited to, one or more individuals' names, an address, a title, and a company. Additionally, the business card information can include a service, such as a service performed by the individual(s), or the company. Additionally, the business information can include other information such as a telephone number, a facsimile number, or an electronic mail address. Additionally, the business information can include coupons, or promotional products. The business information may be printed on one side, or both sides of the business card assembly.

The business card assembly can comprise a sheet of paper, such as ten mil thick card stock. Alternately, the business card assembly can be fabricated from a sheet of plastic. Alternately, the business card assembly can be fabricated from magnetic material, such as a refrigerator magnet. The plurality of business cards 120A-H can be uniquely separated by a series of vertically extending lines 130, and a series of horizontally extending lines 140. As illustrated in FIG. 1, the pattern of business cards 120A-G is rectangular; however, other shapes are within the scope of the invention. For example, the sheet of paper can be a standard size, such as 8-½×11 inches, or legal size paper, and each of the business cards 120A-G can have dimensions comparable to traditional business cards (e.g., two by three and a half inches).

The series of vertically extending lines 130 and the series of horizontally extending lines 140 can comprise any combination of partially-cut, or fully-cut lines. The partial cut can include a cut in the sheet of paper that extends only partially through the paper. Additionally, the fully-cut line can include a cut extending the full thickness of the sheet of paper. For example, the series of vertically extending lines 130, and the series of horizontally extending lines 140 can include a perforation cut. The partially-cut, or fully-cut lines can be prepared using any combination of trimming wheels (rotary knives), die cutting, laser scoring, or chemical or acid etching.

One pattern for defining the series of vertically extending and horizontally extending lines is illustrated in FIG. 1. For example, the frame 110 can include a single piece. Alternatively, the frame 110 can include multiple pieces. Furthermore, the frame can be labeled with information, such as service information associated with the agency responsible for distribution of the business card assembly.

Additionally, for example, the business card assembly can be prepared using the technique(s) described in U.S. Pat. No. 5,853,837, entitled “Laser or ink jet printable business card system”, and U.S. Pat. No. 5,997,680, entitled “Method of producing printed media”; both of which are incorporated herein by reference.

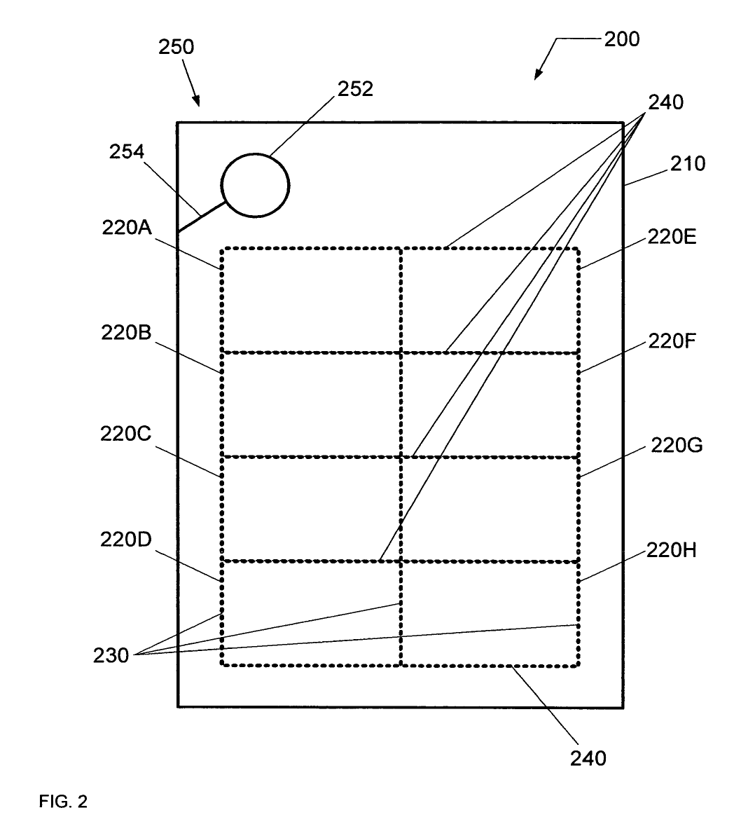

Referring now to FIG. 2, a business card assembly 200 comprising a frame 210 and a plurality of business cards 220A, 220B, 220C, 220D, 220E, 220F, 220G, and 220H according to another embodiment. The business card assembly 200 can include a series of vertically extending lines 230 and a series of horizontally extending lines 240 in order to delineate one business card from another. Additionally, the business card assembly 200 includes an assembly coupling feature 250 configured to attach the business card assembly 200 to a fixture, such as a door knob, door handle, latch, etc. The assembly coupling feature 250 can include a through-hole 252 configured to slip over the fixture. Alternatively, the assembly coupling feature 250 can include a through-hole 252 used in combination with an elastic band, or loop of material to slip over the fixture. Alternatively and desirably, the assembly coupling feature 250 can include a through-hole 252 used in combination with an angled cut 254 configured to permit hanging the business card assembly 200 on the fixture.

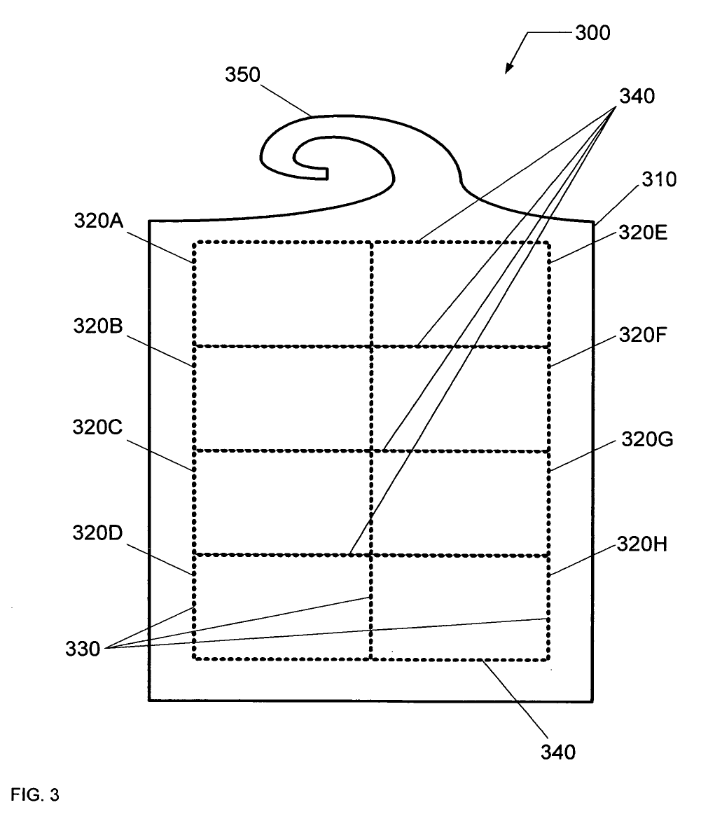

Alternatively, as illustrated in FIG. 3, a business card assembly 300 comprises a frame 310 and a plurality of business cards 320A, 320B, 320C, 320D, 320E, 320F, 320G, and 320H according to yet another embodiment. Additionally, the business card assembly 300 includes an assembly coupling feature 350 for attaching the business card assembly 300 to a fixture, such as a door knob, door handle, latch, etc. The assembly coupling feature 350 can include a hanger (or hook) formed in the business card assembly 300, or configured to attach to the business card assembly 300.

In yet another embodiment, the assembly coupling feature can include an adhesive, or tape coupled to a portion of the rear side of the business card assembly. Alternately, the assembly coupling feature can include magnetic material.

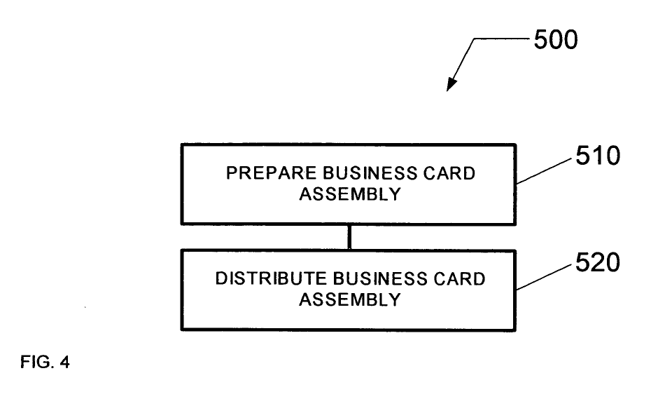

Referring now to FIG. 4, a method of disseminating information is described according to an embodiment of the invention. The method includes a flow chart 500 beginning in 510 with preparing a business card assembly having a frame and a plurality of business cards delineated by one or more lines configured to permit the separation of one or more of the plurality of business cards from the frame. Business or service information can, for example, be printed onto the business card assembly via a printer, or a copier, or a combination thereof. For instance, the printer or copier can include an ink jet printer, or laser jet printer. The business card assembly is further prepared with an assembly coupling feature for attaching the business card assembly to a fixture, such as a door, door knob, door handle, latch, etc.

In 520, business information contained on the business card assembly is disseminated via door-to-door distribution (or canvassing), whereby the business card assembly is coupled to entry ways, or exit ways, or both of residential, commercial, or industrial facilities. For example, the business card assembly is coupled to a door via the assembly coupling feature.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A method for disseminating information comprising:
preparing a business card assembly comprising a frame, a plurality of business cards coupled to said frame and configured to be removed from said frame, and an assembly coupling feature coupled to said frame; and
distributing said business card assembly door-to-door to one or more of a residential, commercial, or industrial facility using said assembly coupling feature to couple said business card assembly to a fixture on said one or more of said residential, commercial, or industrial facility.

2. The method of claim 1, wherein said preparing said business card assembly includes preparing said business card assembly on a sheet of paper.

3. The method of claim 1, wherein said preparing said business card assembly includes preparing said business card assembly on a sheet of magnetic material.

4. The method of claim 1, wherein said preparing said business card assembly with said plurality of business cards includes delineating one business card from an adjacent business card using one or more lines having at least one of a partial cut, or a full cut, or a combination thereof in order to form a perforation that permits separation of said one business card from said adjacent business card, and separation of said one business card from said frame.

5. The method of claim 4, wherein said preparing said business card assembly with said plurality of business cards with said one or more lines having at least one of a partial cut, or a full cut, or a combination thereof includes using one or more of a trimming wheel, die cutting, laser scoring, chemical etching, or acid etching.

6. The method of claim 1, wherein said preparing said business card assembly with said plurality of business cards includes printing business information on at least one of said plurality of business cards using one or more of a printer or a copier.

7. The method of claim 6, wherein said preparing said business card assembly using a printer or a copier includes using one or more of a laser jet printer, or an ink jet printer.

8. The method of claim 1, wherein said preparing said business card assembly with said assembly coupling feature includes preparing said business card assembly with a hole configured to fit over said fixture.

9. The method of claim 8, wherein said preparing said business card assembly with said hole configured to fit over said fixture further includes preparing an angled cut extending from said hole to an edge of said frame.

10. The method of claim 1, wherein said preparing said business card assembly with said assembly coupling feature includes preparing said business card assembly with a hanger coupled to said frame and configured to fit over said fixture.

11. The method of claim 1, wherein said preparing said business card assembly with said assembly coupling feature includes preparing said business card assembly from a magnetic material.

12. The method of claim 1, wherein said distributing said business card assembly via coupling said business card assembly to said fixture includes coupling said business card assembly to a door, a door knob, a door handle, or a latch.

13. A business card assembly comprising:
a frame;
a plurality of business cards coupled to said frame and configured to be removed from said frame; and
an assembly coupling feature coupled to said frame and configured to couple said business card assembly to a fixture on one or more of a residential, commercial, or industrial facility.

14. The business card assembly of claim 13, wherein said business card assembly includes a sheet of paper.

15. The business card assembly of claim 13, wherein said business card assembly includes a sheet of magnetic material.

16. The business card assembly of claim 13, wherein said business card assembly with said plurality of business cards includes delineating one business card from an adjacent business card using one or more lines having at least one of a partial cut, or a full cut, or a combination thereof in order to form a perforation that permits separation of said one business card from said adjacent business card, and separation of said one business card from said frame.

17. The business card assembly of claim 16, wherein one or more lines having at least one partial cut, or a full cut, or a combination thereof is formed using one or more of a trimming wheel, die cutting, laser scoring, chemical etching, or acid etching.

18. The business card assembly of claim 13, wherein said plurality of business cards includes business information printed using one or more of a printer or a copier.

19. The business card assembly of claim 18, wherein said printer or a copier includes one or more of a laser jet printer, or an ink jet printer.

20. The business card assembly of claim 13, wherein said assembly coupling feature includes a hole configured to fit over said fixture.

21. The business card assembly of claim 20, wherein said assembly coupling feature further includes an angled cut extending from said hole to an edge of said frame.

22. The business card assembly of claim 13, wherein said assembly coupling feature includes a hanger coupled to said frame and configured to fit over said fixture.

23. The business card assembly of claim 13, wherein said assembly coupling feature includes a magnetic material.

24. The business card assembly of claim 13, wherein said fixture includes a door, a door knob, a door handle, or a latch.
